(19) United States
(12) Patent Application Publication
(10) Pub. No.: US 2026/0258329 A1
(43) Pub. Date: Sep. 3, 2026

(54) AN APPARATUS FOR CRITICALLY CONTROLLED MATURATION OF SPIRIT AND A METHOD THEREOF

(71) Applicant: UNITED SPIRITS LIMITED, Bangalore, Karnataka (IN)

(72) Inventors: Narendra Manohar RAUT, Bangalore, Karnataka (IN); Nagendra SATHYANARAYANA, Bangalore, Karnataka (IN); Suresh Nama SUBBARAJU, Bangalore, Karnataka (IN); Dilip Kumar SENGUPTA, Bangalore, Karnataka (IN)

(21) Appl. No.: 18/873,353

(22) PCT Filed: Jun. 9, 2023
(86) PCT No.: PCT/IB2023/055970

§ 371 Date: Dec. 10, 2024

(30) Foreign Application Priority Data
Jun. 10, 2022 (IN) 202241033195

(51) Int. Cl. C12G 3/07

(52) U.S. Cl. CPC C12G 3/07

(57) ABSTRACT

The invention discloses an apparatus for controlled maturation of spirit. The apparatus contains a reaction vessel (100) designed to Critically Control Maturation of Spirits (CCMS) to attain consistent quality of the matured spirit irrespective of the geographical location of the maturation site. The temperature, pressure, oxygen and chemical reactions are maintained to achieve the consistent quality of the spirit. The process (200) of maturation of the spirit under controlled conditions. The process (200) mainly comprises reduction of harshness by removal of sulphur compounds, addition of wood chips to impart desired flavour, transformation of wood congeners by temperature and pressure conditions, addition of activated carbon to remove the sharp edges and to obtain a well-rounded matured spirit. The process (200) imparts improved sensory profile to the cask matured spirit.

### PREAMBLE TO THE DESCRIPTION

The following specification describes the invention and the manner in which it is to be performed:

### DESCRIPTION OF THE INVENTION

### Technical Field of the Invention

The present invention relates to an apparatus for maturation of the spirit. More particularly, the invention relates to the apparatus for critically controlled maturation of spirits for different categories of spirits. The invention also discloses a method of maturation of spirit by controlling the specific parameters to deliver consistent quality of matured spirit irrespective of the geography.

### Background of the Invention

The distillation of fermented juices such as wine, starch, plant extracts result in distilled spirits. The list of distilled spirits comprises whisky, brandy, rum, gin, tequila, vodka etc. The characteristics of these alcoholic beverages depends on the type and processing of raw materials, fermentation, distillation, maturation and blending.

The production of ethanol in the distilled spirits is from the sugars present in the raw materials during fermentation, distillation, or maturation. A variety of distilled beverages are matured in wooden casks for several years. The flavor and composition of the drink are transformed during the process of maturation. The time required and the type of cask used are the factors affecting the maturation. The maturation of spirits influences the aroma, taste, flavor, color, and composition. The process of maturation mellows the alcohol characteristics.

The distilled spirits are matured in wooden casks for relative periods of time. The maturity of distilled spirits indicates degree of chemical changes during storage. The use of oak casks and charred wooden casks are predominant for the maturation of distilled spirits. The types of casks used for maturation of distilled spirits are charred casks, ex-sherry casks, ex-bourbon casks, refill casks regenerated casks etc. The temperature conditions affect the rate and results of maturation of distilled spirits. The process of maturation of distilled spirits moderates the volatility and smoothness. The loss of ethanol content is increased if the casks encounter higher temperatures.

The compounds responsible for unpleasant flavor such as dimethylsulphide, dimethyldisulphide, methional etc. are absorbed by the carbon present in the inner surface of the cask. The scorched surface of the wooden casks release compounds such as tannins, lignins, aromatic aldehydes such as vanillin and coniferaldehyde into the spirit responsible for their flavor and aroma. These compounds are oxidized during ageing by the atmospheric oxygen.

The intensity of heat treatments affects the concentration of aromatic compounds present in the distilled spirits. Vanillin occurs naturally in wood as well as by the degradation of lignin. The content of vanillin is increased by heat treatment. The degradation of lignin additionally produces coniferaldehyde, sinapaldehyde, syringaldehyde, and vanillic and syringic acids. The tannins produced have a sensory impact. The tannins transform during heat treatment and maturation to obtain polyphenols.

The repeated use of casks often depletes the desirable characteristics. The effectiveness decreases over time. Upon continuous usage, the casks lose the ability to incorporate flavor and color and eliminate undesirable compounds. The casks are rejuvenated by scrapping and recharring. Charring makes the wood compounds more soluble.

The geographical characteristics have a notable impact on the maturation of distilled spirits. The geographical growth location imparts significant taste variations as the concentration of volatile compounds varies. The volatile aromatic profile effects the sensory perception of the alcoholic beverage.

The quality of a matured spirit from a cask is highly dependable on the climatic conditions of the geographic location where the spirit is stored. More particularly, the climatic conditions such as temperature, atmospheric pressure, humidity, wind flow, atmosphere of surroundings (seashore or hills), etc. influence the air exchange and extraction dynamics of wood congeners into the distilled liquid during maturation in a conventional wooden cask.

As a result, the spirit matured at different geographical locations of the globe impart different tastes and flavors to the beverage. In addition, it can also be an advantage from a consumer point of view to have varieties of flavors of beverages associated with different geographical locations, however, the variance can also bring supply complexity when desiring uniformity in the spirit produced at different locations and climatic conditions.

For example, in India, the climatic conditions drastically vary across the length and breadth of the country and hence producing a uniform quality of matured spirit from distilleries at different locations in the country is an exceptional challenge. Also in India, due to the warm weather conditions, the casks used for maturation of the spirit, on reusing multiple times, become exhausted rapidly which causes a change in quality of matured spirit.

The phenomenon of changing matured spirit quality from one cask filling cycle to another is found across the globe and is particularly prominent in India due to the faster rate of wood extraction in warm climatic condition. This issue is addressed by using the skill of experienced blenders, who can blend spirits from different distilleries and from different cask refill cycles to bring uniformity in the quality of matured spirit. However, it takes a considerable amount of time to reach a certain level of expertise and master the special skill set required.

The maturation of distilled spirits in casks are dependent on various factors. The aromatic volatile profile changes depending on the geography. The repeated usage of casks leads to various changes in the composition of the distilled spirits. The uniformity of color, flavor and aroma are very much essential and are transformed during the process of maturation of distilled spirits.

Hence, there is a need for process of production of distilled spirits where the maturation characteristics are maintained with consistent color, flavor, and aroma independent of the geographical location and with reduced time frame.

The Patent Application WO1996US12001 entitled “Oak aged alcoholic beverage extract and accelerated whisky maturation method” discloses an oak aged alcoholic product and a method for accelerated whiskey maturation. The process does not make use of food grade solvent. The mature oak aged alcoholic beverage comprises bourbon, scotch, whisky, rum, tequila, and wine. The process of producing an extract of matured oak comprises addition of food grade solvent to mature oak aged alcoholic beverage followed by mixing and allowing a first layer, comprising the food grade solvent, flavors, color, alcohol and water, to separate from a second layer. The first layer is separated from the second layer and substantially removing the food grade solvent from the first layer and the extract is produced. The food grade solvents used comprises ethyl acetate and liquid carbon dioxide. The accelerated whiskey maturation method comprises combining alcoholic distillate with toasted oak chips. A mixture of the alcoholic distillate and the toasted oak chips is obtained. The mixture is heated, aerated and oxygenated for 5-40 days. The toasted oak chips are removed. 100-500 g of toasted oak chips are added to the alcoholic distillate.

The Patent Application WO2014US48421 entitled “System and method for rapid maturation of distilled spirits” discloses a process for rapid production of distilled spirits. The process comprises contacting unmatured spirit with wood to obtain distilled spirit mixture. The temperature of the distilled spirit mixture is maintained between 140-170° F. for 12-336 hours in a sealed vessel or under reflux for the prevention of evaporation of volatile compounds. The spirit comprises sugar cane spirits, grain spirits, fruit spirits, and agave spirits. The process does not comprise an added acid. The characteristics of distilled spirits associated with mature distilled spirit comprises obtaining a marker concentration of a chemical compound in a target matured distilled. The unmatured distilled spirit is contacted with wood to form a distilled spirit mixture. The marker concentrations of the distilled spirit mixture are measured. The distilled spirit mixture is heated to a temperature between about 140° F.-170° F. in a sealed vessel or under reflux such that evaporation of volatile compounds is prevented until the marker concentration of the distilled spirit mixture reaches the target marker concentration. The marker concentrations are measured by mass spectrometry, high performance liquid chromatography, gas chromatography and calorimetric methods.

The Patent Application EP20170705931 entitled “Maturation process of at least one alcoholic liquid with the recovery of volatile compounds and apparatus for making the same” discloses a process for maturing alcoholic liquid. The process comprising a container with alcoholic liquid made of wood. The process of maturation of alcoholic liquid comprises use of an airtight or semi-airtight chamber located in a wine cellar which contain alcoholic liquid. The container is partly made of wood and an internal atmosphere comprises oxygen. The maturation of the alcoholic liquid in the container releases volatile compounds into the internal atmosphere. The extraction of a portion of the internal atmosphere from the chamber to obtain a gas mixture to be treated. The gas mixture is separated to be treated into residual gas mixture depleted in the volatile compounds. The portion of residual gas is evacuated outside of the chamber. The admission of air into the chamber is by forced convection. The recovered liquid forms an alcoholic beverage. The oxygen content is measured in the volatile compounds of the enclosure. The process of extraction is carried out by an extractor. The separation is performed by separation modules PSA, VSA or TSA comprising adsorbent bed for the adsorption of air from gas mixture. The separation is fractionated to obtain the recovered liquid and other recovered liquids comprising a portion of the volatile compounds present in the gas mixture.

The Patent Application US201816215847 entitled “Accelerated Maturation Process (A.M.P.) device” discloses an accelerated maturation process (A.M.P.) device which cycles a base liquid from a holding tank through a maturation chamber and returns the maturing base liquid to the original holding tank. The device comprises a liquid base from one chamber and continuously cycles it through a second chamber. The liquid flows through a Permeable Medium. The newly infused liquid is cycled out of the second chamber and returned to the first chamber. the cyclic flow of the liquid continues generating an infused liquid with an increasing concentration of the Permeable Medium comprising part of the liquid. The device comprises embodiments where the characteristics of permeable medium, charred American oak permeable medium are retained. The fermented liquid comprises fermented grain, fermented fruit, or fermented honey. The liquid-based distillate comprises whiskey, whisky, rum, tequila, mescal, brandy, and gin.

The Patent Application WO2020US14078 entitled “Assemblies, systents, and methods for maturation of distilled spirits” discloses an assembly for maturing distilled spirits. The assembly comprises a shipping container with two side walls, a floor, a roof, a closed end, and an open end defining an internal cavity, a racking system positioned within the internal cavity of the shipping container, the racking system including a racking column attached to a pair of racking rails, an external surface of each of the two side walls has a light reflective value of less than about 10 and an external surface of the roof has a light reflective value of about 75 or more to induce a convective air flow around the racking system. The external surface of the roof has a light reflective value of about 88. The shipping container comprises louvers for adjusting the air flow. The racking column and racking rails comprise of wood. The pair of racking rails are spaced at a distance from one another sufficient to support the one or more casks upon positioning the one or more casks in a horizontal configuration.

### SUMMARY OF THE INVENTION

In order to overcome the drawbacks of the state of art, the present invention relates to an apparatus for maturation of the spirit. The apparatus is specially designed for critically controlled maturation of spirits (CCMS). The invention also discloses a method of maturation of spirit by controlling the specific parameters to deliver consistent quality of matured spirit irrespective of the geographical location of the maturation site.

The apparatus for maturation of the spirit is configured to control steps and the reaction parameters for maturation of the spirit to produce a beverage with the qualities of a matured spirit. The apparatus comprises a reaction vessel having spirit inlet, a water inlet, a hot water jacket, a water outlet, a glass wool, a set of impellers, a variable frequency drive, a wood chip cage, an activated carbon cage, a wood chip inlet, an activated carbon inlet, a wood chip outlet, an activated carbon outlet, an air displacement inlet, an oxygen gas inlet, a dissolved oxygen meter, a pressure/vacuum release valve, a pressure gauge, a temperature sensor, and a spirit outlet.

The apparatus of the invention comprises a spirit inlet through which the distilled spirit is introduced into the reaction vessel for maturation. The water into the reaction vessel is introduced through the water inlet and the temperature in the reaction vessel is achieved and maintained using the hot water jacket using the water inlet and the water outlet surrounding the reaction vessel.

The hot water jacket is insulated by a glass wool to prevent any loss of heat through the walls of jacket. The uniformity and consistency of the temperature in the reaction vessel is assured by axial stirring the spirit using an impeller that is operated by a top mounted motor controlled by variable frequency drive.

The reaction vessel further comprises the wood chip cage and the activated carbon cage to hold the wood chips and the activated carbon respectively and enables the introduction of the wood chips and the activated carbon through the wood chip inlet and the activated carbon inlet respectively placed at the roof of the reaction vessel. The wood chip outlet and the activated carbon outlet aids in removal of insoluble wood chips and activated carbon through gravity due to its J-shape.

The dissolved oxygen is introduced through the oxygen gas inlet and the concentration of the dissolved oxygen is measured using the dissolved oxygen meter. The air displacement valve purges any trapped air displaced by oxygen gas during the creation of an oxygen-rich gas environment and pressure inside the apparatus. The pressure/vacuum release valve expels any displaced air or gas from the reaction vessel. The pressure gauge monitors the pressure in the reaction vessel and the temperature sensor placed at the top portion of the reaction vessel monitors the temperature in the reaction vessel. The spirit outlet allows the collection of the matured spirit from the reaction vessel.

The invention also discloses a process for controlled maturation of spirit. The process is broadly comprises the elimination of harshness of the spirit, addition of wood congeners, interactive reactions amongst the wood congeners to develop flavour complexity in the spirit to be matured and rounding of spirit.

The process of present invention and cask matured spirit (CMS) are compared with respect to flavour congeners namely fruity, floral, spicy, waxy, astringency, sweet, bitter and malty and results indicated that most of the congeners in the spirit from present invention are in line with cask matured spirit, which supports a desirable sensory profile.

The process of the present invention may be adjusted and optimized by reference to a benchmark spirit associated with a particular market or geographical location.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates the apparatus for critically controlled maturation of spirit.

FIG. 2 illustrates a flow chart for a process of controlled maturation of spirit.

FIG. 3 illustrates the examples of the critical reactions during the maturation of the spirit in a wooden cask.

FIG. 4 illustrates the relative reduction in sulphur compounds that typically contribute to harshness under process conditions of the invention.

FIG. 5 graphically illustrates a change in taste profile due to cask strength, i.e. as used in cask maturation of a spirit.

FIG. 6a illustrates the lignin degradation compounds i.e. oxidative transformation of polyphenolic aldehydes.

FIG. 6b graphically represents oxidative transformation of coniferaldehyde to vanillin and vanillin to vanillic acid during the process of present invention.

FIG. 6c graphically represents oxidative transformation of sinapaldehyde to syringaldehyde and syringaldehyde to syringic acid during the process of present invention.

FIG. 7 illustrates the results of the comparison of the sensorials of matured spirits from critically controlled maturation and the cask maturation processes.

FIGS. 8a and 8b illustrates the results of the comparison of the flavour congeners responsible for the key attributes of matured spirits from critically controlled maturation and cask maturation processes.

FIGS. 9a and 9b illustrates the results of the consistency in flavour congeners by the process of critically controlled maturation in 4 numbers of individual batches.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

In order to more clearly and concisely describe and point out the subject matter of the claimed invention, the following definitions are provided for specific terms, which are used in the following written description.

The term “Maturation of Spirit” refers to a process of storing distilled spirits or wines in barrels for a specific period of time to remove harsh flavors from the raw alcohol while adding distinct flavor characteristics found in the barrel's wood.

The present invention overcomes the drawback of the existing state-of-the-art technologies by providing an apparatus specific for the maturation of spirit and maintaining the specific parameters to improve the quality of the matured spirit. The invention also discloses a method of maturation of a spirit to deliver a consistent quality, particularly across any geography of the globe, in a reduced timeframe.

An embodiment of the invention discloses an apparatus for maturation of the spirit. The apparatus is specially designed to critically control the process parameters for maturation of the spirit to produce a beverage with the qualities of a cask matured spirit.

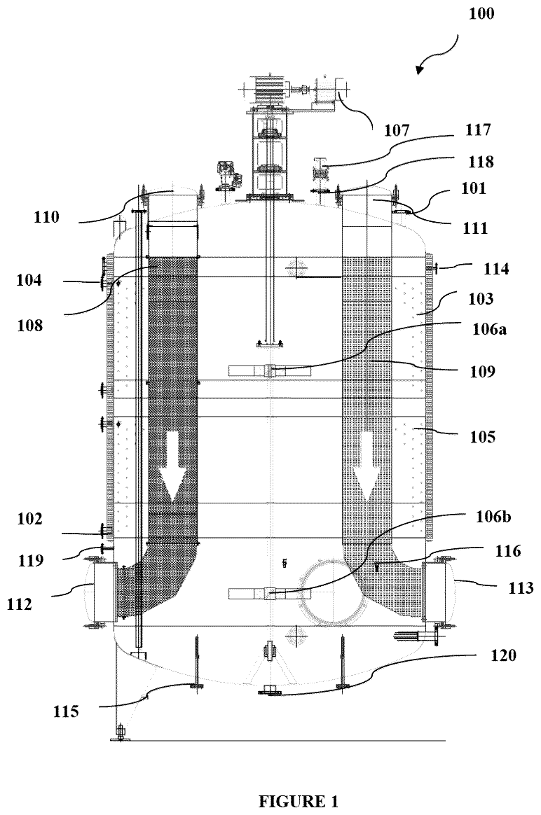

FIG. 1 illustrates the apparatus for maturation of the spirit. The apparatus-of the present invention is configured to control steps and the reaction parameters for maturation of the spirit to produce a beverage with the qualities of a matured spirit. The apparatus includes reaction vessel (100) configured to critically controlled maturation, i.e. the parameters of temperature, oxygen gas pressure, addition of wood chips, addition of activated carbon and stirring of spirit during the method at commercial scale. The reaction vessel (100) comprises a spirit inlet (101), a water inlet (102), a hot water jacket (103), a water outlet (104), a glass wool (105), a set of impellers (106a), (106b), a variable frequency drive (107), a wood chip cage (108), an activated carbon cage (109), a wood chip inlet (110), an activated carbon inlet (111), a wood chip outlet (112), an activated carbon outlet (113), an air displacement inlet (114), an oxygen gas inlet (115), a dissolved oxygen meter (116), a pressure/vacuum release valve (117), a pressure gauge (118), a temperature sensor (119), and a spirit outlet (120).

The maturation of the spirit is achieved using the reaction vessel (100), which comprises a spirit inlet (101) at a top portion of the reaction vessel (100), through which the distilled spirit is introduced into the reaction vessel (100) for maturation. The water into the reaction vessel (100) is introduced through the water inlet (102) and the temperature in the reaction vessel (100) is achieved and maintained using the hot water jacket (103) using the water inlet (102) and the water outlet (104) surrounding the reaction vessel (100). The hot water jacket (103) is insulated by a glass wool (105) to prevent any loss of heat through the walls of jacket. The uniformity and consistency of the temperature in the reaction vessel (100) is assured by axial stirring the spirit using an impeller (106a, 106b) which is operated by a top mounted motor controlled by variable frequency drive (107). The wood chip cage (108) and the activated carbon cage (109) are J shaped cages located in the reaction vessel (100) to hold the wood chips and the activated carbon respectively. The J shaped wood chip cage (108) and the activated carbon cage (109) enables the introduction of the wood chips and the activated carbon through the wood chip inlet (110) and the activated carbon inlet (111) respectively placed at the roof of the reaction vessel (100) and unloading using wood chip outlet (112) and the activated carbon outlet (113) respectively placed at the side wall of the reaction vessel (100). The wood chip outlet (112) and the activated carbon outlet (113) aids in removal of insoluble wood chips and activated carbon through gravity. Optionally, additional J shaped cages may be utilized for inclusion of reaction additives to the reaction vessel (100).

The oxygen gas inlet (115) allows the introduction of oxygen into the distilled spirit and the concentration of the dissolved oxygen is measured using the dissolved oxygen meter (116). The air displacement valve (114), placed at the top portion of the reaction vessel (100) purges any trapped air displaced by oxygen gas during the creation of an oxygen-rich gas environment and pressure inside the reaction vessel (100). The pressure/vacuum release valve (117) expels any displaced air or gas from the reaction vessel (100). The pressure gauge (118) placed at the top portion of the reaction vessel (100) monitors the pressure in the reaction vessel (100), the temperature sensor (119) placed at the top portion of the reaction vessel (100) monitors the temperature in the reaction vessel (100). The spirit outlet (120), placed at the bottom portion of the reaction vessel (100) allows the collection of the matured spirit from the reaction vessel (100).

The reaction vessel (100) of the present invention is designed to maintain the critically controlled maturation of spirits such as flow and quantity of spirit in the reaction vessel (100), flow of hot water in jacket, flow of oxygen gas, rotation speed of impeller etc. are microprocessor controlled to achieve and maintain desired temperature, pressure, and concentration of oxygen in the spirit.

The collection and monitoring of this data is useful to construct a digital twin for the process, enabling prediction of maturation characteristics in a beverage subject to treatment according to the invention.

The present invention also discloses a process of maturation of spirit in the apparatus. According to an embodiment, the method of the invention is simple, rapid and robust for distilled liquid maturation, from a scalable standpoint, to produce a consistent and quality matured spirit in line with established expectations.

The process of maturation of the spirit of the present invention is broadly categorized into four phases of chemical changes such as elimination of harshness of the spirit, addition of wood congeners using wood material, interactive reactions amongst the wood congeners to develop flavour complexity in the spirit to be matured and rounding of spirit by use of activated carbon. As a result of said chemical changes, the consistent quality of matured spirit in line with a cask matured spirit benchmark is achieved irrespective of the climatic and geographical conditions.

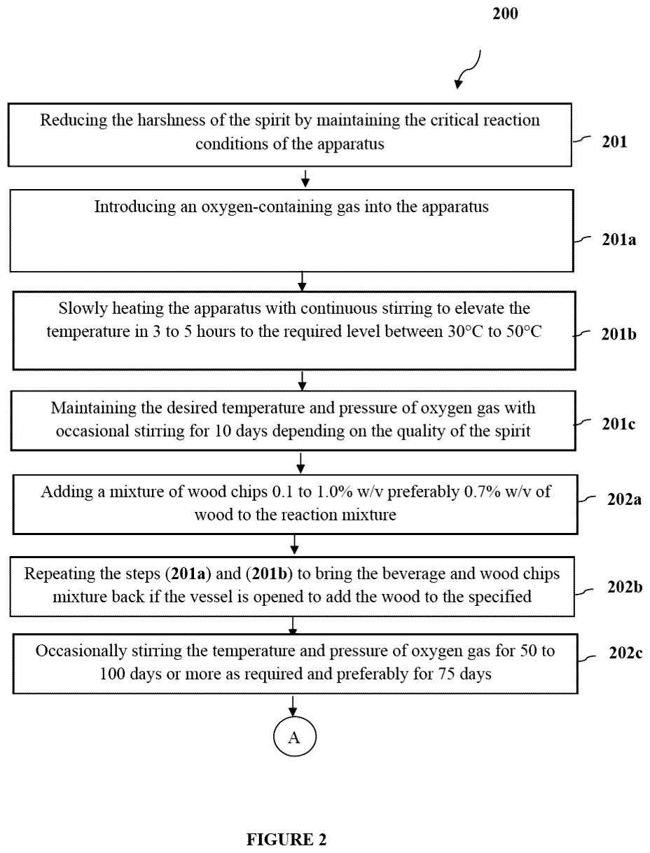

FIG. 2 illustrates a flow chart for a process of maturation of the spirit. The process (200) comprises the step (201) of reduction of harshness of the spirit by maintaining the critical reaction conditions of the apparatus. The step (201) of reduction of harshness is achieved by step (201a) of introducing an oxygen-containing gas into the reaction vessel and maintaining a required pressure of 0.3 to 2.0 kg/cm² (30-200 kPa) preferably 0.5±0.1 kg/cm² and the oxygen gas concentration may vary from 21 to 100%, wherein the oxygen gas that is >99% pure. At step (201b), the reaction vessel is slowly heated with continuous stirring to elevate the temperature in 3 to 5 hours to the required level between 30° C. to 50° C. preferably 38.0±1.0° C. At step (201c), the desired temperature and pressure of oxygen gas with occasional stirring is maintained for a duration of 7 to 28 days and preferably 10 days depending on the quality of the spirit. The above process parameters are demonstrated at commercial level of 30,000 L to get significant reduction in harshness of new make spirit, which is one of the key steps for maturation spirit to get premium cues. At step (202), i.e., after reducing the harshness, the wood chips are added to enhance the flavor of new make spirit. At step (202a), a selected portion of mixture of wood chips, 0.1 to 1.0% w/v preferably 0.7% w/v of wood is added to the reaction vessel. The wood chips used are from varied toasting levels such as light toasted, medium toasted and heavy toasted to get the desired woody flavours. At step (202b), the steps (201a) and (201b) are repeated to maintain if the reaction vessel remains sealed or bring the beverage and wood chips mixture back if the reaction vessel is opened to add the wood to the specified conditions of temperature and pressure. In one form of the method, the wood chips are maintained in the headspace of a sealed or pressurized vessel but held out of contact with the beverage until required. However, in an alternative form, the reaction vessel is depressurized for addition of woodchips and subsequently restored to the required elevated pressure conditions. At step (202c), the temperature and pressure of oxygen gas with occasional stirring is maintained for 50 to 100 days or more as required and preferably for 75 days. At step (203), and after achieving the desired wood flavor, activated carbon is then used to reduce any sharp edges and to obtain a well-rounded matured spirit. The proportion of activated carbon and process conditions are optimized to achieve well rounded matured spirit without disturbing the flavour profile with the carbon. It is noteworthy that activated carbon should not be contacted with the beverage for too long which is why the specified time is relatively short and at the end of the process. At step (203a), coconut shell based granular activated carbon at a concentration in a range between 0.30 to 0.70% w/v preferably at 0.50±0.05 % w/v is added and preferably after the reaction vessel is depressurized. At step (203b), the reaction vessel is slowly cooled with stirring to reduce the temperature, e.g., to ambient or to 30° C., whichever is higher. For consistency, 30.0±1.0° C. is used preferred at atmospheric pressure. At step (203c), the stirring of spirit is continued slowly with a constant speed of approximately 50 rpm up to 30 hours and at step (203d), the spirit is filtered using 100-micron bag filters to obtain a well-rounded matured spirit. The process (200) results in processed beverage, which is ready to bottle and transport.

The new make spirit needs to be matured in oak casks to remove undesirable attributes, raw notes and to mellow down the spirit while adding desired woody notes and complexity. The maturation period of a fresh malt spirit in an oak cask is typically 1.5 to 2 years in Indian conditions.

The maturation of spirit in the apparatus is a result of four types of chemical reactions namely additive reactions, subtractive reactions, absorptive reactions, and interactive reactions.

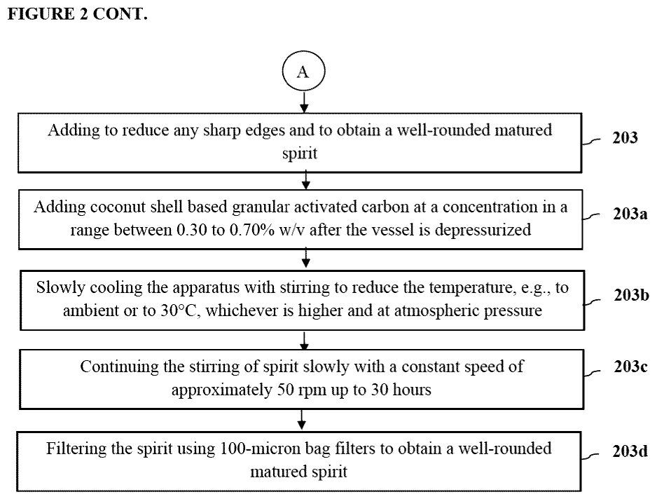

FIG. 3 illustrates the examples of the critical reactions during the maturation of the spirit in a wooden cask. The maturation of spirit in the apparatus involves simulation of the multiple chemical changes and critical reactions occurring in cask. The critical reactions that occur during the maturation of the spirit in the reaction vessel comprises addition reactions, subtractive reactions, absorptive reactions, and interactive reactions. As a result of these reactions, the consistent quality and predictability of spirit in every batch is achieved.

The harshness of the spirit is to be removed in the preliminary phase of maturation and is achieved by carefully understanding the physical parameters in the reaction vessel and optimizing temperature, oxygen pressure and time to get desired mellowness in the spirit.

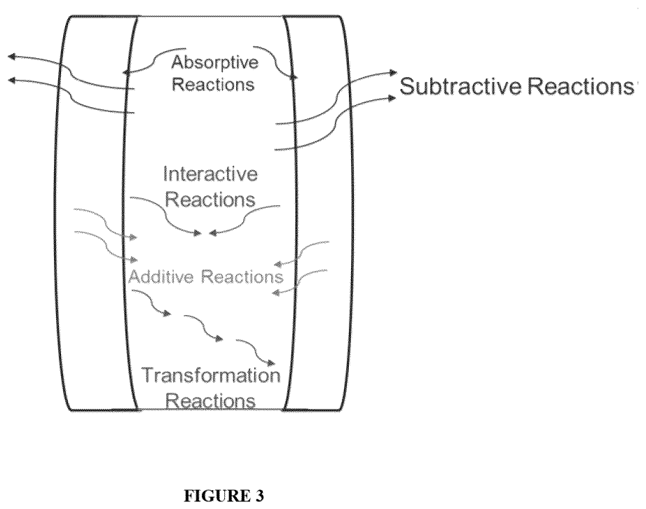

FIG. 4 illustrates the relative reduction in sulphur compounds that typically contribute to harshness under process conditions of the invention. The removal of harshness of the spirit is achieved by removal of the sulphur compounds. The removal of harshness of the spirit is achieved by optimizing the physico-chemical parameters such as temperature, oxygen pressure and time to get desired mellowness in the spirit. This replicates the subtractive reactions occurring during maturation of spirit in a cask, where a perceived harshness due to sulphur compounds present in the distillate at ultra-trace levels get reduced due to loss of sulphur compounds through the cask wall during air exchange. The sulphur compounds are removed by oxidizing the sulphur compounds to carbon dioxide and water. The sulphur compounds are reduced from initial levels (say 100%) over time as depicted in FIG. 4. The sulphur compounds namely thiophene, 2-methyl thiophene, 2-5-dimethyl thiophene, di-methyl di-sulphide, di-methyl tri-sulphide and S-methyl thioacetate in the spirit are reduced over time. The conditions are optimized to oxidize the harshness contributing sulphur compounds while avoiding over oxidation of alcohol.

According to an embodiment, it is a particular consideration of the present invention to select the correct mixture of light, medium and heavy toasted wood chips at an effective proportion. Wood chips are introduced into the reaction vessel to replicate the extraction and desired level of wood congeners into spirit, as traditionally achieved by a wooden cask inner layer.

The selection of suitable type of wood along with their proportions plays an important role and it refers to the additive reaction.

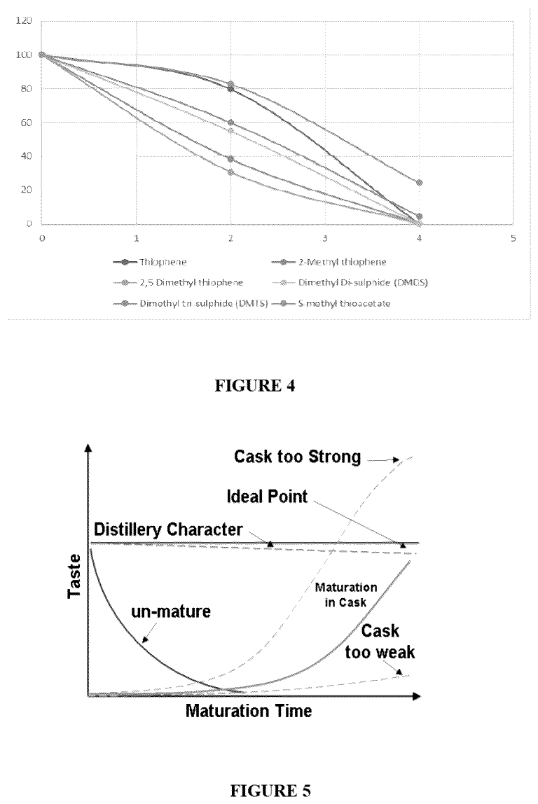

FIG. 5 graphically illustrates a change in taste profile due to cask strength, i.e., as used in cask maturation of a spirit. The wood chips are introduced into the reaction vessel to replicate the extraction and desired level of wood congeners into spirit, as traditionally achieved by a wooden cask inner layer. The taste of the spirit varies with the type of wood congeners used and the toasting levels of the wood. As depicted in FIG. 5, the level of wood congeners in a matured spirit is highest when cask is very strong i.e., a fresh cask and the level of wood congeners decreases typically by 30% to 50% after every usage of the cask and hence the quality of matured spirit changes after every reuse of the cask until the cask become “dead” and unusable for maturation of spirit. However, in the present invention, a new load of wood chips is introduced to the J-shaped cage at each batch and hence the proportion and mix of different wood chips remains constant resulting in consistent quality and predictability of spirit in every batch.

In addition to the additive reactions and subtractive reactions, the process of the maturation of the spirit also comprises a transformation reaction. This is evident by the formation of vanillin by maintaining the oxygen gas environment with the pressure condition.

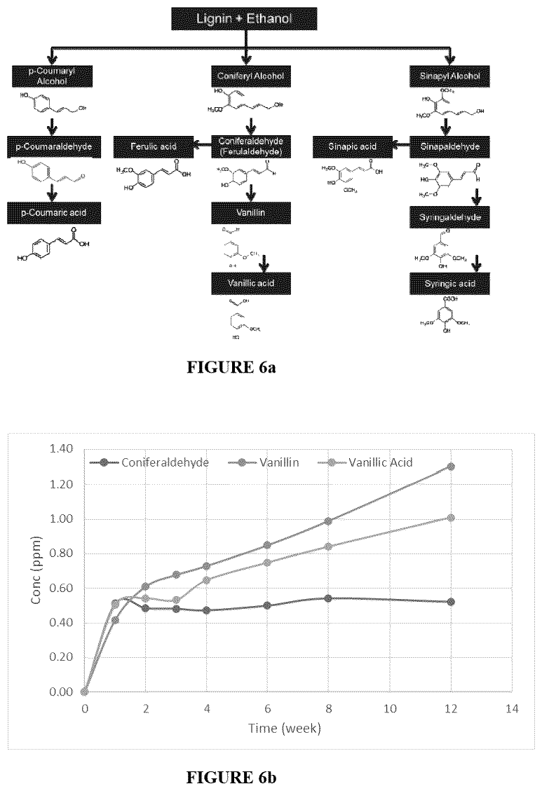

FIG. 6a illustrates the lignin degradation compounds i.e., oxidative transformation of polyphenolic aldehydes. This process typically occurs in a cask by air exchanges through the wooden cask wall during the maturation period (often measured in years). FIG. 6 illustrates the formation of vanillin, a key flavour and maturation marker formed by the oxidation of coniferaldehyde, which is further transformed into vanillic acid.

FIG. 6b graphically represents oxidative transformation of coniferaldehyde to vanillin and vanillin to vanillic acid during maturation The oxidative transformation of coniferaldehyde results in formation of vanillin initially which is further converted to vanillic acid with maturation under said process conditions of the oxygen gas environment with the pressure. During this process, coniferaldehyde is constant, indicating its rate of formation from coniferyl alcohol is equal to rate of conversion in vanillin. However, the rate of formation of vanillin is more than the rate of its conversion into vanillic acid. As a result, the vanillin concentration increases in the disclosed process. Vanillic acid is an oxidative transformation of vanillin and steadily increases during the maturation process. The increase in level of vanillin and vanillic acid under the oxidative environment conditions is evidence of the interactive and transformation reactions occurring in reaction vessel, comparable to a cask spirit during the maturation.

FIG. 6c graphically represents oxidative transformation of sinapaldehyde to syringaldehyde and syringaldehyde to syringic acid during maturation. Similar to conversion of vanillin to vanillic acid, the maturation process also involves the transformation reaction of sinapaldehyde to syringaldehyde and syringaldehyde to syringic acid due to oxidation reaction. However, the reaction kinetics depend on the dissolved oxygen level in the spirit. Air under pressure is used to increase dissolved oxygen level in the spirit, but compared to pure oxygen, four to five times more air pressure is needed to achieve the desired level of dissolved oxygen. In the present case, 99% pure oxygen gas with 0.5 kg/cm² pressure is sufficient to maintain a desired level of dissolved oxygen (15-20 ppm).

The final phase of the process involves the addition of activated carbon, which assists in replicating or synthesizing the absorptive reactions that occur in a cask i.e., over a charred inner layer of its wooden stave wall, which reduces the sharp edges to provide a well-rounded spirit. The selection of activated carbon, its concentration and contact time with the liquid is optimized to obtain a well-rounded spirit without losing essential congeners or key flavours.

The process of the maturation of the spirit as per the present invention of matured spirit under critically controlled conditions is compared with the cask maturation process.

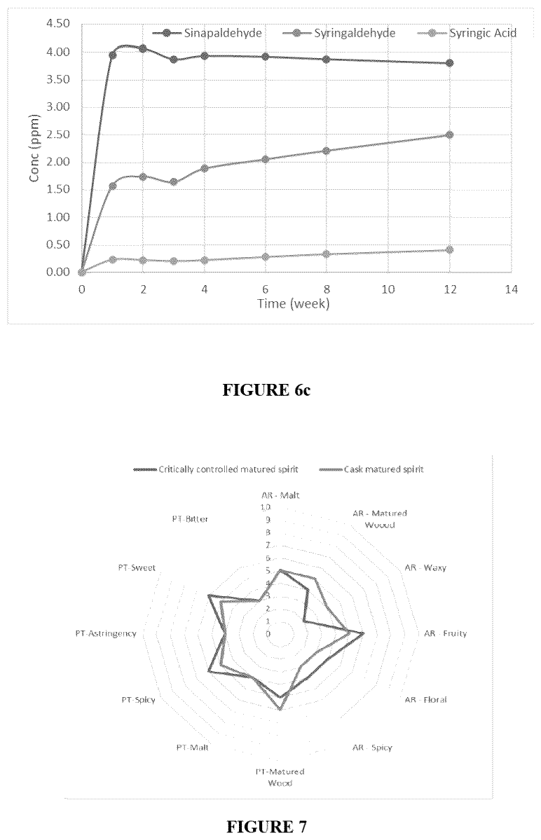

FIG. 7 illustrates the sensorial results of the comparison of the process of critically controlled maturation is compared with the cask maturation process. The sensorial attributes namely waxy, fruity, floral, spicy, malty, astringency, sweet and bitter are compared in the spirit matured using critically controlled conditions and cask maturation process. As depicted in the FIG. 7, the critically controlled maturation was found to be quite comparable and better than the cask maturation process, specifically for fruity, floral, spicy, sweet and malty attributes except the waxy attribute. In addition, the matured wood attributes are increased with an increase in process time and/or amount of wood.

Further, the flavour congeners are quantified using High Performance Liquid Chromatography (HPLC), Gas Chromatography Flame-ionization Detection (GC-FID) and by chemical methods for comparison of their presence in spirits from critically controlled maturation and cask maturation processes.

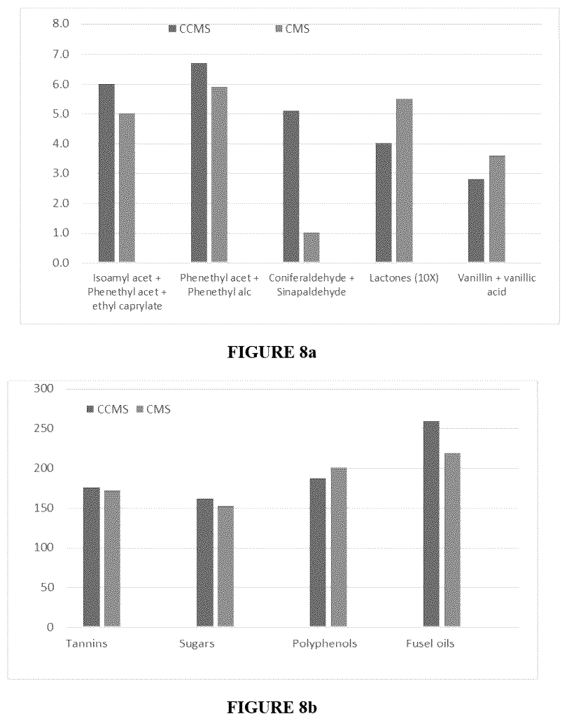

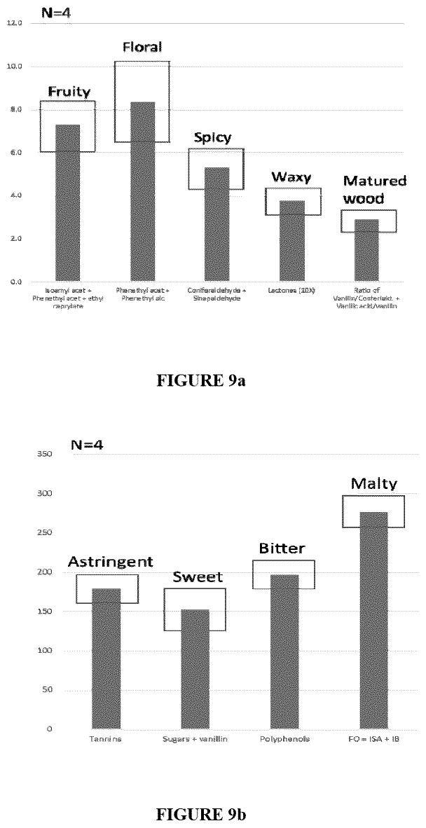

FIGS. 8a and 8b illustrates the results of the comparison of two processes (CCMS & CMS) with respect to quantification of flavour congeners responsible for key sensorials. The results indicates that most of the congeners in the spirit by critically controlled maturation are in line with spirit from cask maturation, which supports a desirable sensory profile and found to be consistent in the desired analytical range in four consecutive batches as depicted in FIGS. 9a and 9b.

FIGS. 9a and 9b illustrates the results of consistency in the key flavours of spirits from 4 numbers of consecutive batches by the present invention. The key flavours viz. fruity, floral, spicy, waxy, astringency, sweet, bitter and malty, and their related congeners on analysis in the spirits are found to vary in a narrow range, endorsing the consistency in quality of spirits amongst 4 individual batches.

The present invention disclosing a process for critically controlled maturation of spirit and the apparatus to maintain the required conditions results in producing the taste profile of a matured distilled spirit without the need for long-terin storage in casks typically associated with maturation and irrespective of the geographical location for maturation.

The process of the present invention based on controlling maturation of a distilled beverage and associated apparatus for executing the process involves providing a distilled spirit into the reaction vessel, elevating the temperature and pressure in an oxygen-rich atmosphere, introducing wood chips and, subsequently, activated carbon to the reaction vessel. To perform the process, the reaction vessel comprises a heating and/or cooling means for modifying and maintaining a temperature of the beverage. A gas inlet means optionally provides for modifying and maintaining a pressure within the vessel via an oxygen-containing gas, at least one porous enclosure for receiving and holding wood chips and/or activated carbon to be maintained in contact with the beverage and a stirring means.

The process of the present invention may be computer controlled to produce a ready to drink beverage equivalent to a cask-matured spirit benchmark. In one example the reference is a two-year-old Indian matured malt spirit matured under Indian environment.

The process of the present invention may be adjusted and optimized by reference to a benchmark spirit associated with a particular market or geographical location. In addition, digital twin models may be used to predict parameters and recommend selection of additives for achieving the desired benchmark.

The apparatus and the process of the present invention is useful for production of matured spirit with consistent quality irrespective of the geography of maturation site. The process with reduction of harshness by process conditions to reduce sulphur compounds, wood flavour addition by selected mix and proportion of wood chips such as light, medium and heavy levels of toasting, the transformation of wood congeners by process conditions namely temperature, oxygen gas pressure and time critically modelled to provide desired output and finally rounding of spirit by activated carbon using selected proportion and treatment time, without losing balance and critical flavors enables the process more effective and useful for production of matured spirit which is in line with a cask matured spirit with respect to the quantification of the key congeners and the sensory profile of spirit.

The specific process parameters are achieved with specific design of the apparatus which allows the maturation of spirit with consistent quality.

We claim:

1. An apparatus for maturation of a spirit with critically controlled steps and the reaction parameters to improve the quality of the spirit, the apparatus comprises a reaction vessel (100) comprising:
a. a spirit inlet (101) placed at the top portion of the reaction vessel (100), through which the distilled spirit is introduced into the reaction vessel (100) for maturation;
b. a water inlet (102) to introduce water into the reaction vessel (100);
c. a hot water jacket (103) to maintain and temperature of the reaction vessel (100);
d. a water outlet (104) to drain water out of the reaction vessel (100);
e. a glass wool (105) insulating the hot water jacket (103) to prevent any loss of heat through the walls of jacket;
f. at least two impellers (106a, 106b) for axial stirring the spirit and are operated by a top mounted motor controlled by variable frequency drive (107);
g. a wood chip cage (108) is a J shaped cage to hold the wood chips and to enable the introduction of the wood chips through the wood chip inlet (110) placed at the roof of the reaction vessel (100);
h. an activated carbon cage (109) is a J shaped cage to hold the activated carbon and to enable the introduction of activated carbon through the activated carbon inlet (111);
i. a wood chip outlet (112) placed at the side wall of the reaction vessel (100) to remove insoluble wood chips through gravity;
j. an activated carbon outlet (113) placed at the side wall of the reaction vessel (100 to remove insoluble activated carbon through gravity;
k. an air displacement valve placed at the top portion of the reaction vessel (100) to purge any trapped air displaced by oxygen gas during the creation of an oxygen-rich gas environment and pressure inside the reaction vessel (100);
l. an oxygen gas inlet (115) to allow the introduction of the dissolved oxygen into the distilled spirit and the concentration of the dissolved oxygen is measured using a dissolved oxygen meter (116);
m. a pressure/vacuum release valve (117) to expel any displaced air or gas from the reaction vessel (100);
n. a pressure gauge (118) placed at the top portion of the reaction vessel (100) to monitor the pressure in the reaction vessel (100);
o. a temperature sensor (119) placed at the top portion of the reaction vessel (100) to monitor the temperature in the reaction vessel (100); and
p. a spirit outlet (120) placed at the bottom potion of the reaction vessel (100) to allow the collection of the matured spirit from the reaction vessel (100).

2. The apparatus as claimed in claim 1, wherein the reaction vessel (100) maintains the critically controlled maturation of spirits such as flow of spirit in the reaction vessel (100), flow of hot water in jacket, flow of oxygen gas, rotation speed of impeller are microprocessor controlled to achieve and maintain optimum temperature, pressure, and concentration of oxygen in the spirit.

3. A process for maturation of spirit using the apparatus, the process (200) comprising the steps of:
a. reduction of harshness of the spirit by maintaining the critical reaction conditions of the reaction vessel (201); wherein the reduction of harshness is achieved by:
i. introducing an oxygen-containing gas into the reaction vessel and maintaining a required pressure (201a);
ii. slowly heating the reaction vessel with continuous stirring to elevate the temperature in 3 to 5 hours to the required level between 30° C. to 50° C. preferably 38.0±1.0° C. (201b); and
iii. maintaining the desired temperature and pressure of oxygen gas with occasional stirring for a duration of 7 to 28 days and preferably 10 days depending on the quality of the spirit (201c);
b. adding the wood chips to enhance the flavor of new make spirit (202) and is achieved by:
i. adding a mixture of wood chips 0.1 to 1.0% w/v preferably 0.7% w/v of wood to the reaction mixture (202a);
ii. repeating the steps (201a) and (201b) to maintain if the reaction vessel remains sealed or bring the beverage and wood chips mixture back if the reaction vessel is opened to add the wood to the specified conditions of temperature and pressure (202b); and
iii. occasional stirring for 50 to 100 days and preferably for 75 days to maintain the temperature and pressure of oxygen gas (202c);
c. adding activated carbon to reduce the sharp edges and to obtain a well-rounded matured spirit and is achieved by the steps of:
i. adding coconut shell based granular activated carbon at a concentration in a range between 0.30 to 0.70% w/v preferably at 0.50±0.05 % w/v and preferably after the reaction vessel is depressurized (203a);
ii. slowly cooling the reaction vessel with stirring to reduce the temperature, to ambient or to 30° C., whichever is higher and at atmospheric pressure (203b);
iii. continuing the sturing of spirit slowly with a constant speed of approximately 50 rpm for 10 to 30 hours (203c); and
iv. filtering the spirit using 100-micron bag filters to obtain a well-rounded matured spirit (203d).
wherein the process results in the matured spirit with consistent quality irrespective of the geography of the maturation site.

4. The process as claimed in claim 3, wherein the pressure during the process is maintained in a range between 0.3 and 2.0 kg/cm² (30-200 kPa) preferably 0.5±0.1 kg/cm² and the oxygen gas concentration from 21% to 100%.

5. The process as claimed in claim 3, wherein the wood chips used are selected from varied toasting levels such as light toasted, medium toasted and heavy toasted to get the desired woody flavours.

6. The process as claimed in claim 3, wherein the process is achieved through Critically Controlled Maturation of Spirits (CCMS) to attain consistent quality of the matured spirit.

7. The process as claimed in claim 3, wherein the process resulted in improved fruity, floral, spicy, sweet and malty attributes of the matured spirit.
